(19) United States
(12) Patent Application Publication
(10) Pub. No.: US 2017/0314741 A1
(43) Pub. Date: Nov. 2, 2017

(54) METHODS AND DEVICES FOR A MULTI-USE LED LIGHT BAR

(71) Applicant: ESL Vision, Salt Lake City, UT (US)

(72) Inventors: Michael Brendan Gleeson, Salt Lake City, UT (US); Jeffrey Allen Provolt, Salt Lake City, UT (US)

(73) Assignee: ESL Vision, Salt Lake City, UT (US)

(21) Appl. No.: 15/581,698

(22) Filed: Apr. 28, 2017

Related U.S. Application Data
(60) Provisional application No. 62/329,862, filed on Apr. 29, 2016.

(51) Int. Cl. F21K 9/272; F21V 17/08; F21S 4/28; F21Y 2115/10; F21Y 2103/10

(52) U.S. Cl. CPC F21K 9/272; F21V 17/08; F21S 4/28; F21Y 2103/10; F21Y 2115/10

(57) ABSTRACT

Embodiments of the disclosure relate to retrofitting LED light bars into fluorescent tubular style lamp fixtures as well as integrating LED light bars into new lamp fixtures. In various embodiments a single light bar may be utilized with multiple style base ends to allow it to retrofit into a variety of existing fixtures. Some embodiments offer multiple mounting options on an LED light bar for existing lamp fixtures so that electrical utilities' rebate requirements can be met with a single LED light bar assembly.

### CROSS-REFERENCE TO RELATED APPLICATIONS

This application claims priority to U.S. Provisional Patent Application No. 62/329,862 filed Apr. 29, 2016, the entire contents and disclosure of which are hereby incorporated by this reference.

### TECHNICAL FIELD

Embodiments described in this application relate generally to lighting products, their mechanical features for attachment, and associated means and methods, and more specifically, retrofitting fluorescent tubular style fixtures as well as integrating the disclosed device(s) into new fixtures with a light-emitting diode (“LED”) light bar, in particular linear tubes.

### BACKGROUND

Current light bar technologies for retrofit applications cause businesses to maintain inventory for a multitude of lighting configurations. Cost incurred range from maintaining inventory of similar light bars, sans the mechanical end style for mounting in existing fixtures, can be costly and difficult.

When upgrading fluorescent tubular lamps to LED tubes or fixtures, there are many electrical utility rebates that offer a wide range of financial benefits to help reduce energy consumption. Many of these rebates have requirements stipulating how the replacement lighting is installed. Depending upon the utility and/or the rebate the requirements of the retrofit vary. For instance, some rebates mandate that the retrofitting lamp cannot utilize the existing receptacle, (i.e., tombstone).

This wide range of installation requirements (e.g., fluorescent light tombstone socket options) and selection of different lighting options makes it cumbersome for electrical supply houses, distribution centers, installers, etc., to have all the needed items readily available.

In applications where new lighting is being installed and no longer require the tombstone sockets, a mounting clip can be used instead.

Overall, it would be advantageous to have a means for variations in mounting option applications such that a single light bar can qualify for different financial rebates in retrofits or reduce inventory while allowing variations in product offerings.

### BRIEF SUMMARY

The disclosed embodiments and device(s) overcome these above-described requirements by offering a single light bar that can easily transform to fit the requirements of both the rebates and function of retrofitting/installing a fixture or light source.

Having the ability to utilize the same fixture for a multitude of needs provides a larger variety of rebate and use offerings. For instance, a vapor tight fixture, utilizing the clips and/or rotatable end cap base adaptors can distribute the light in various patters based upon the angle of the mounting application. The variation in angle can allow the same fixture to be used in multiple applications.

Embodiments of the disclosure generally relate to retrofitting LED light bars into fluorescent tubular style lamp fixtures as well as integrating LED light bars into new lamp fixtures. A single light bar can be utilized with multiple style base ends that allows it to retrofit into a variety of existing fixtures. This results in a method for offering multiple mounting options on an LED light bar for an existing lamp fixture so that electrical utilities' rebate requirements can be met with a single LED light bar assembly.

A major advantage of the disclosed device(s) is offering a single LED light bar source that has the capability of utilizing any existing fixture receptacle and/or can be mounted independent of the receptacle. Electrical Utilities offer rebates for adoption of LED lighting to reduce energy consumption. These rebates have a myriad of technical requirements regarding how the existing lamp receptacle is utilized when the LED light bar replaces a fluorescent light. In some instances, the fluorescent lamps' tombstone receivers must stay in place but in some instances the tombstones can be removed. Removal of the tombstones in a lighting retrofit is sometimes regarded as less labor intensive since the fluorescent ballast, its high voltage wiring, and tombstones can all be removed as a single assembly. These components are then replaced by LED light bars, the LED power supply and dedicated direct current (DC) wiring. When the tombstones must remain in place, the high voltage wiring is cut and the fluorescent lamp ballast is removed. The interchangeability of the end base adaptors allow for either adaptation and installation to the existing fixture. Moreover, if the rebate requirements state that the tombstones must remain in place but the end base adaptors cannot be used, this invention will allow the light bar to fit in between the existing fixture receptacles with the interchangeable base adaptors removed. This ability of the invention helps reduce the additional labor and inventory needed by businesses to meet the rebate requirements in different localities.

Accordingly, various embodiments of the disclosure and disclosed device(s) have a base cap on both sides. This base cap has a receiving adaptor end base that can either not have any adaptor and be used as a traditional light bar with separate mounting clips or can use an interchangeable base adapter. The interchangeable base offers several adaptors that will fit in the existing light fixtures receptacle. Standard receptacles in the field are G13 for 4-foot tubes and Fa8 for 8-foot tubes. Other standard receptacle options can easily be created to this interchangeable adapter base system.

Embodiments of the disclosure and device(s) also generally relate to offering the interchangeable base to any size length of light bar. This will allow for the reduction of inventory but create a large array of offerings. Further, they provide the ability to offer an interchangeable and removable end base adaptor which greatly increases the number of stock keeping units (SKU) that can be offered while reducing the quantity of lamps needed to be in stock. These novelties pass the same benefits of additional flexibility in product offerings to distributors. Other advantages, benefits and applications may exist.

### BRIEF DESCRIPTION OF THE DRAWINGS

Advantages of the various embodiments described in this disclosure will be apparent to those of ordinary skill in the art from the following detailed description and the appended drawings:

FIG. 1 shows a broken view of an embodiment of the lamp assembly;

FIG. 2 shows an exploded view of an embodiment of the lamp assembly and various convertible base adapters;

FIG. 3 shows a side view A-A of an embodiment of adapter base 16;

FIG. 4 shows a perspective broken view of t an embodiment of the lamp assembly along with depicting cutting planes for sections B-B and C-C;

FIG. 5 shows Section B-B from FIG. 4;

FIG. 6 shows Section C-C from FIG. 4;

FIG. 7 shows an exploded top view of embodiments of the end base and metal extrusion;

FIG. 8 shows an exploded side view of embodiments the end base and metal extrusion;

FIG. 9 shows a perspective view of the end base and metal extrusion assembled according to an embodiment of the disclosure;

FIG. 10 shows the end view of two light bars assembled with an angular mounting clip according to an embodiment of the disclosure;

FIG. 11 shows a front view of a rotating head of an embodiment of a rotating base adapter;

FIG. 12 shows a side view of an embodiment of a rotating base adapter;

FIG. 13 shows an embodiment of the locking feature of the rotating base adapter;

FIGS. 14 and 15 show an existing light fixture being retrofitted with the LED light bars disclosed herein;

FIG. 16 shows a front view of a light fixture including an embodiment of an angled clip;

FIG. 17 shows a right side view of an embodiment of an angled clip;

FIG. 18 shows a perspective view an embodiment of an angled clip;

FIG. 19 shows a front view of a light fixture having an embodiment of a vertical clip;

FIG. 20 shows a right side view of an embodiment of a vertical clip;

FIG. 21 shows a perspective view of an embodiment of a vertical clip;

FIGS. 22A and 22B show the insertion of an angled clip into a fixture according to an embodiment of the disclosure; and

FIG. 23 shows a new light fixture fitted with embodiments of angled and vertical clips supporting light bars.

### DETAILED DESCRIPTION

In the following detailed description, reference is made to the accompanying drawings which form a part hereof, and in which is shown by way of illustration specific embodiments in which the disclosure may be practiced. These embodiments are described in sufficient detail to enable those of ordinary skill in the art to practice the disclosure. It should be understood, however, that the detailed description and the specific examples, while indicating examples of embodiments of the disclosure, are given by way of illustration only and not by way of limitation. From this disclosure, various substitutions, modifications, additions rearrangements, or combinations thereof within the scope of the disclosure may be made and will become apparent to those of ordinary skill in the art.

In accordance with common practice the various features illustrated in the drawings may not be drawn to scale. The illustrations presented herein are not meant to be actual views of any particular method, device, or system, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or method. In addition, like reference numerals may be used to denote like features throughout the specification and figures.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof. Some drawings may illustrate signals as a single signal for clarity of presentation and description.

Disclosed is a multi-use light bar to ease installation and assembly. More particularly, but not by way of limitation, the disclosure relates to a multi-use light bar that includes interchangeable base adaptors that are designed to be fastened to existing lamp receptacles, e.g., G13 (bi-pin), Fa8 (single pin), R17D (protruding end cap). This allows for a single light bar to readily emulate different mechanical mounts. Other embodiments of the end cap adaptors include rotatable bases, connectors linking one light bar to the next and/or other mounting methods to existing receptacles in fixtures or to ease assembly in new fixtures.

Also disclosed are mounting clips that may be used if the light bar is not utilizing the existing fixture receptacles. The LED light bar is supportable with mounting clips and/or a receptacle that readily attach to a fixture and/or location via, e.g., self-tapping screws or other affixing methods. Such mounting clips snap into the light bar's (or bars') longitudinal grooves to hold it in place either between the existing receptacles or in other such locations. Additionally, for new fixtures the disclosed device(s) can be easily mounted in the grooved clips or receptacle for the light bar. Light bars may be installed at fixtures to change light output, change beam pattern, or change kelvin options, using the existing fixtures. For example, if an existing fixture is adhered to a specific location and light is provided to a specific target (e.g., a refrigerator door light, a closet light, an oven light a car light, etc.), the devices and techniques described herein may be used to install a light bar that distributes light at different intensities, beam patterns, with more efficient power consumption characteristics, etc.

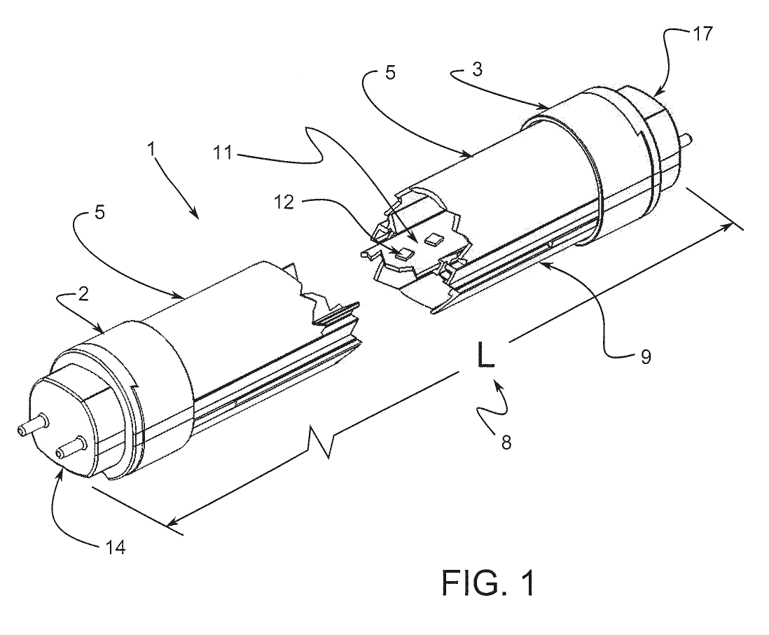

With reference to FIG. 1, an LED light bar 1 is shown that is depicted having a breakaway within its length. Light bar 1 consists of end base 2, 3, lens 5, metal extrusion 9, and circuit card assembly 11. In some embodiments, metal extrusion 9 can be of materials other than metal such as plastics.

Depicted on circuit card 11 and along its length are LEDs 12 that are commonly arranged in a linear pattern. Dimension “L” 8 indicates that the overall length, which can be nearly any practical length required for this type of lighting design. A pair of base adapters 14, 17 are utilized at each end of light bar 1 enabling it to fit standard light fixtures. Lens 5 is typically a translucent plastic usually of a white color, but could be created in other colors or made water clear.

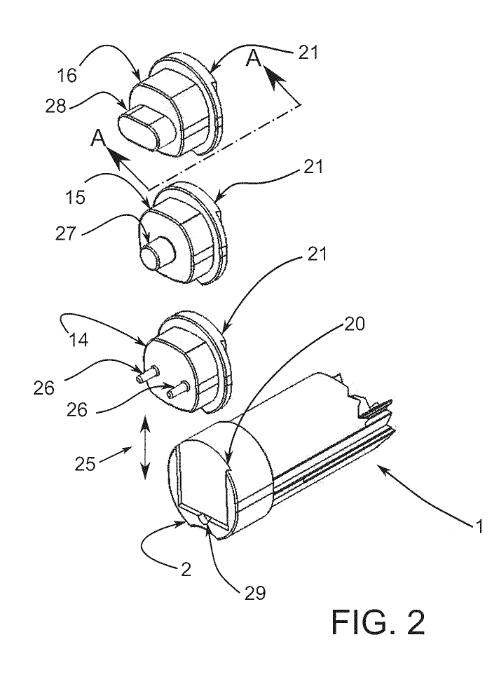

Now referring to FIG. 2, is shown more detail of the end of light bar 1. Particularly are shown connecting adapters 14, 15, and 16. Each of the adapters have their own respective pins 26, 27, and 28, which are both standard sizes to the lighting industry and are all made of electrically nonconductive materials. End pins 26 could be made of metal, but would not be connected to any electrical circuit. Pins 26, 27, and 28 are meant to be both an adaptive element in order to adapt to existing electrical hardware while also forming a structural element to hold the light bar 1 in an existing lamp fixture (not shown). Dovetail 21 is a common geometric detail of end adapters 14, 15, and 16 and can be received in the direction of arrow 25 by a mating dovetail 20 which is part of base adapter 2, 3. The open side of dovetail 20 is always radially located to the same side as lens 5 so as to maintain the securest attachment when light bar 1 is located overhead using base adapters 14, 15, 16. Base adapters 14, 15, and 16 are meant to be used as respective pairs when used with light bar 1. Light bar 1 is also meant to be used independent of base adapters 14, 15, 16 in another embodiment.

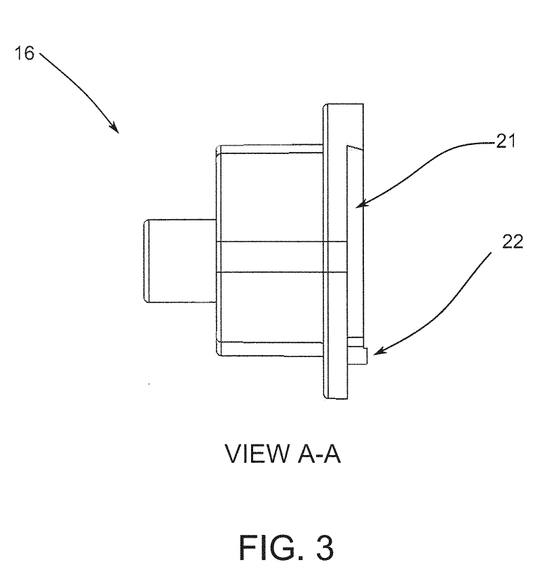

Referring now to FIG. 3, shown is a side view A-A of adapter base 16. Common geometry to all interchangeable base adapters 14, 15, 16 are dovetail 21 locking boss 22. As any one of base adapters 14, 15, 16 are a mated with base end 2, 3 via dovetail 20, 21 locking feature 22 received by notch 27. Locking feature 22 and notch 27 are created such that the adapter base 14, 15, 16 can be released again from end base 2, 3 by finger pressure pushing them apart.

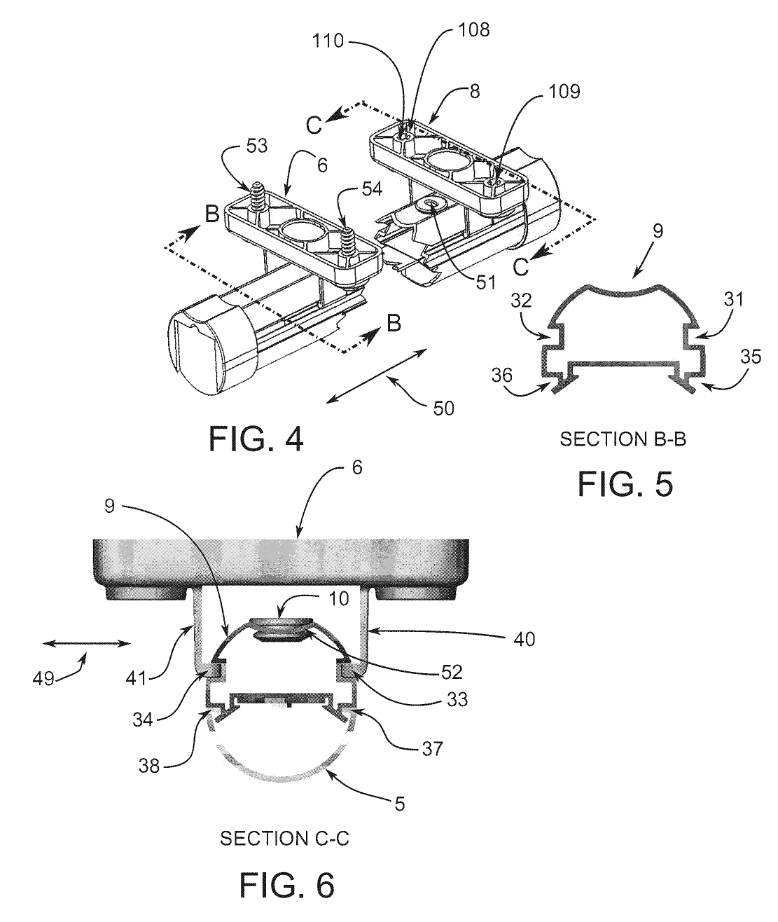

Referring now to FIGS. 4, 5, and 6, shown is a perspective view of LED light bar 1 along with its respective SECTION VIEWS B-B and C-C. Mounting of light bar 1 to an existing light fixture (not shown) is accomplished by the use of mounting clip 6, 8 in two positions along with threaded fasteners 53, 54. Now with regards to FIG. 5, SECTION B-B is showing geometric details of metal extrusion 9 which embodies symmetric and opposite grooves 31, 32 and 35, 36 the purpose of which are then shown in FIG. 6, SECTION C-C. Clip 6 has legs, 40, 41, which can flex slightly in direction of arrow 49. The flexure of legs 40, 41 allows these to open as they slide over metal extrusion 9. Legs 40, 41 are then biased allowing feet 33, 34 to engage into grooves 31, 32 and hold light bar, 1 in place. Grooves 31, 32 run the length of light bar 1 and allow a pair of mounting clips 6, 8 to be positioned in any practicable position along metal extrusion 9 in the directions of arrow 50. Flexibility of legs 40, 41 also allow for the light bar 1 to be detached from clip 6, 8 without having to remove threaded fasteners 53, 54. To ease overhead installation, holes 108, 109 in clips 6, 8, have a geometric star pattern 110 that protrudes within holes 108, 109. Pattern 110 allows fasteners 53, 54 to be started into holes 108, 109 and held by their threads as a self-holding method.

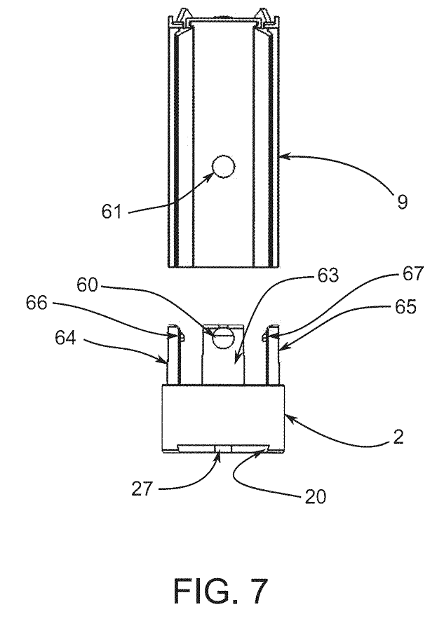

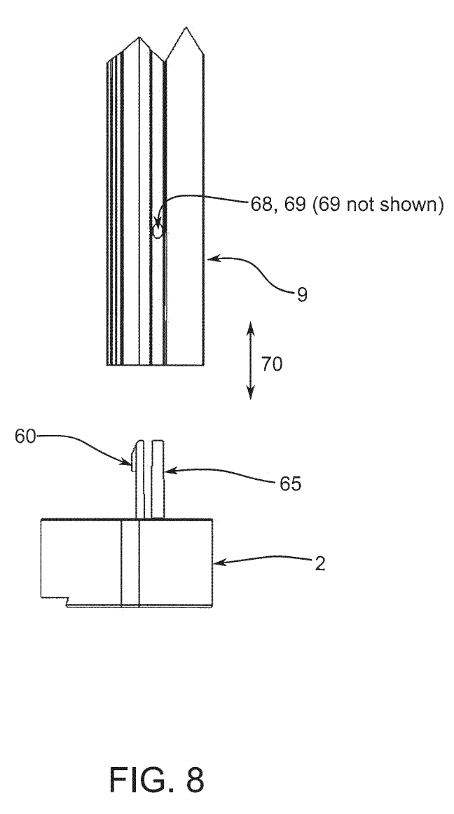

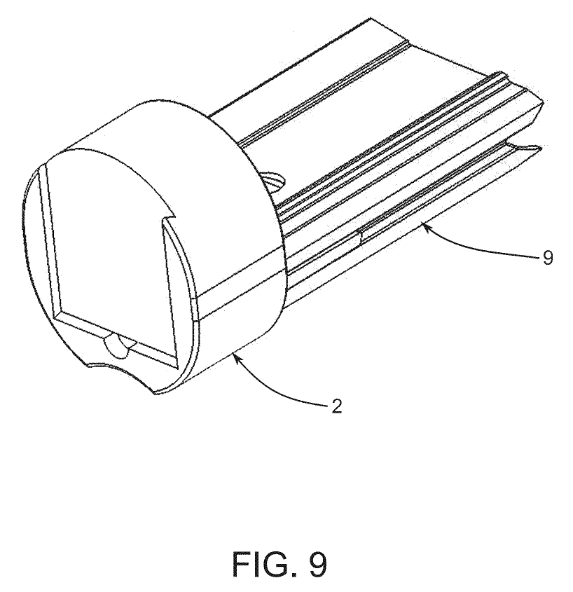

Now referring to FIGS. 7, 8, 9 are shown only the metal extrusion 9 and base cap 2. Base cap 2, 3 are used to close the entire light bar assembly 1 without adhesives or threaded fasteners. Fastening of end base 2 to extrusion 9 or end base 3 to extrusion 9 is accomplished using snap geometric features. Legs 63, 64, 65 are flexible members allowing them some bias ability. Boss features 60, 66, 67 communicate and are received in extrusion holes 61, 68, and 69 (69 not shown, but exactly opposite of hole 68, FIG. 8) when moved together in the direction shown by arrow 70. Biasing from legs 63, 64, 65 keep boss features 60, 66, 67 in their respective holes. Completed mate of end base 2 and extrusion 9 is shown in perspective view FIG. 9. Opposite end of extrusion 9 of light bar 1 is assembled in exactly the same way between extrusion 9 and end base 3.

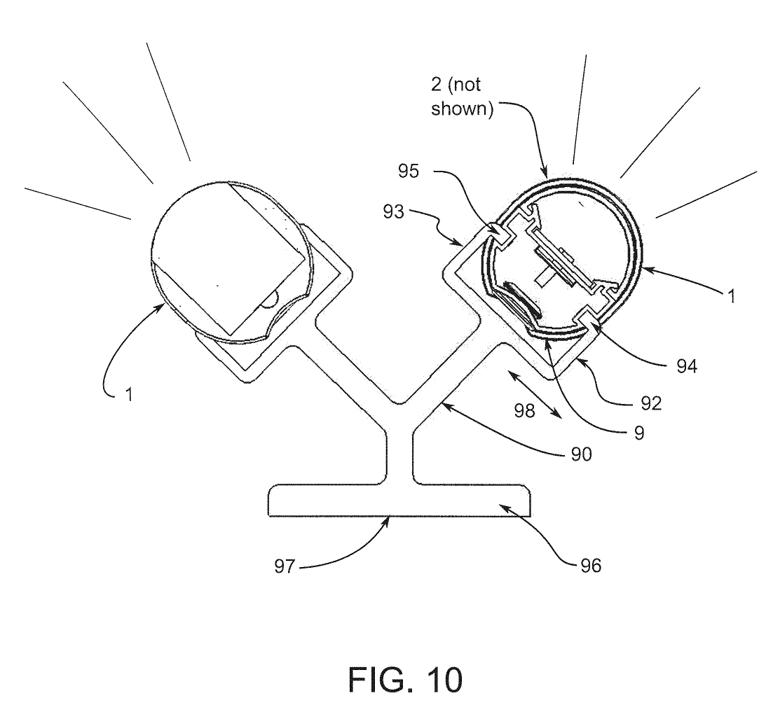

Referring to FIG. 10, what is shown in FIG. 10 is multi-clip adapter 90 holding a pair of light bars 1 on angles relative to one another and base feature 96 (end base 2 is not shown on the right side of FIG. 10). In one embodiment, the multi-clip 90 is adapted to hold a pair of light bars 1 at a 90° angle relative to one another, 45° relative to the Base features 96.

Multi-clip 90 adapts light bar 1 in situations where a direction of light beams are required for best implementation of light bar 1. Multi-clip 90 has legs 92, 93 which can flex slightly in direction of arrow 98. The flexure of legs 92, 93 allows these to open as they slide over metal extrusion 9. Legs 92, 93 are then biased allowing feet 94, 95 to engage into grooves 31, 32 of extrusion 9 (see FIG. 5) and hold light bar, 1 in place. Grooves 31, 32 run the length of extrusion 9 of light bar 1 and allow a pair of mounting multi-clips 90 to be positioned in any practicable position along metal extrusion 9 in the direction of its length 8. Multi-clip 90 has a planar mounting surface 97 that can be attached to any other planar mounting surface with threaded fasteners, adhesives, or similar fasteners known in the art. Base features 96 could be of other geometric shapes (i.e., curved) to allow for mounting to surfaces other than planar ones.

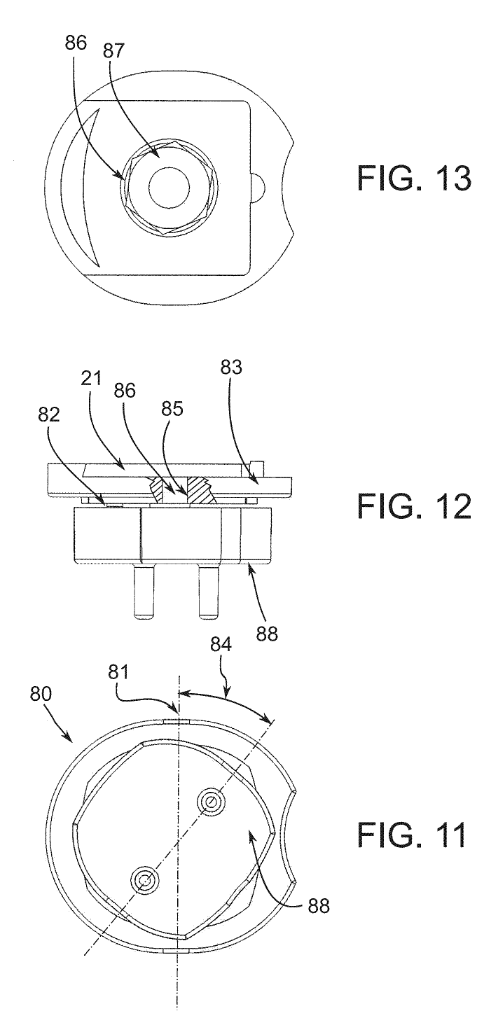

Referring now to FIGS. 11, 12, and 13 is rotational adapter base 80 comprising base adapter 83 and rotating head 88. Similar to adapter bases 14, 15, 16, adapter base 83 has dovetail 21 for mating with base adapter 2, 3 and their dovetail 20. Rotating head 88 has an integral axle 86 that is received by bore 85 in base adapter 83. Axle 86 and bearing 85 allows a relative rotation of rotating head 83 to base adapter 83 shown by centerline 81 and curved arrow 84. When a pair of rotational base adapters 80 is mated with LED light bar 1, the light can be rotated to a position for optimum lighting of an area. A ball detent 82 enables a temporary locking feature between rotating head 88 and rotational adapter base 83 to predetermined angles relative to one another. Rotation head 88 is held to adapter base 83 by hex threaded fastener 87 along with biasing belleville washer 86.

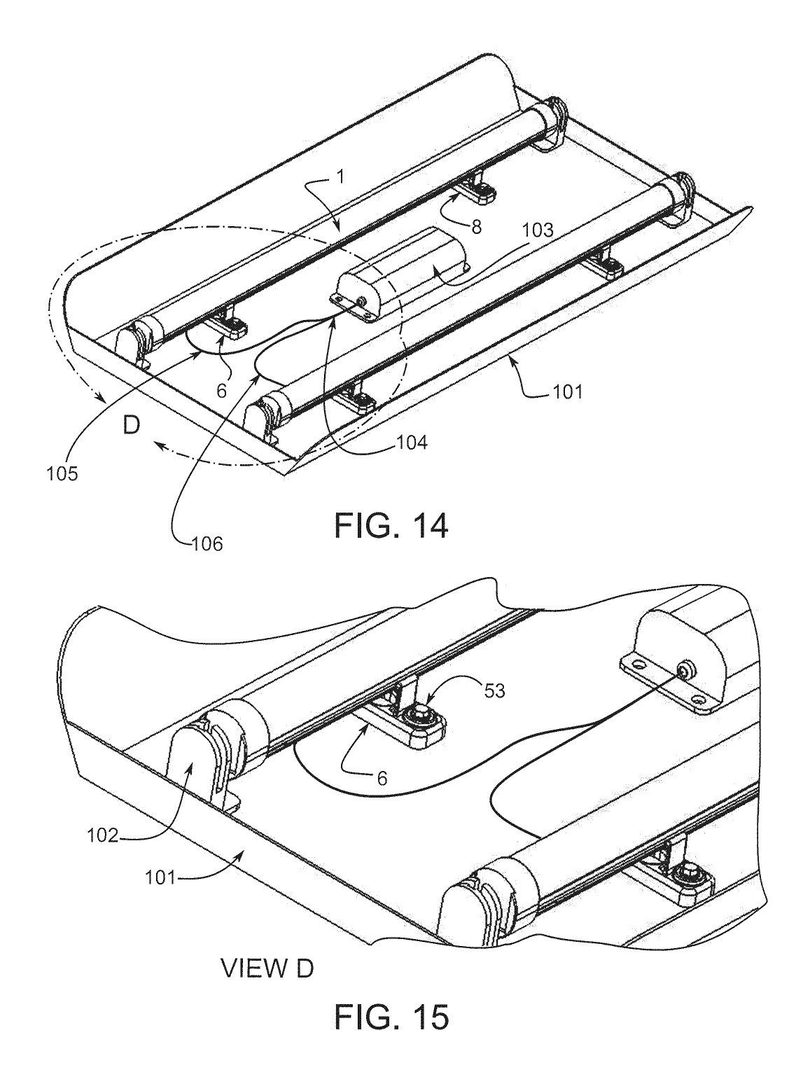

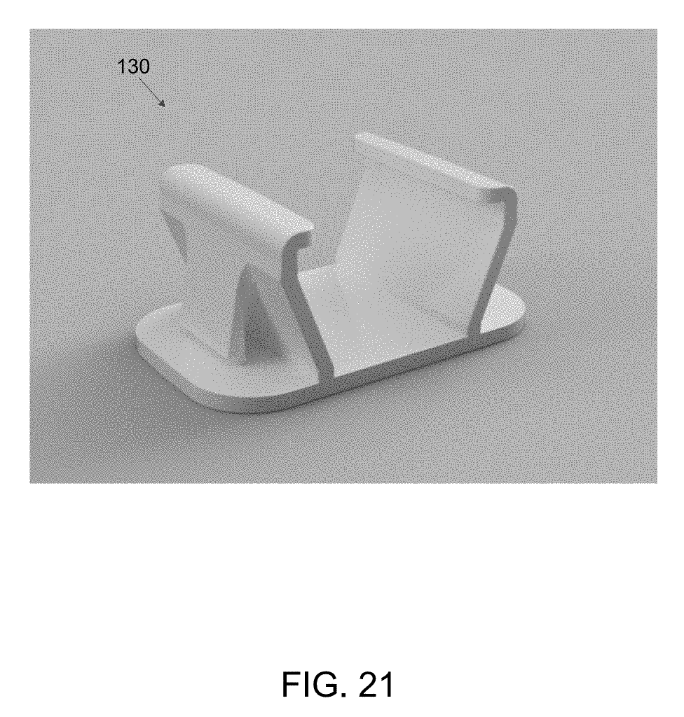

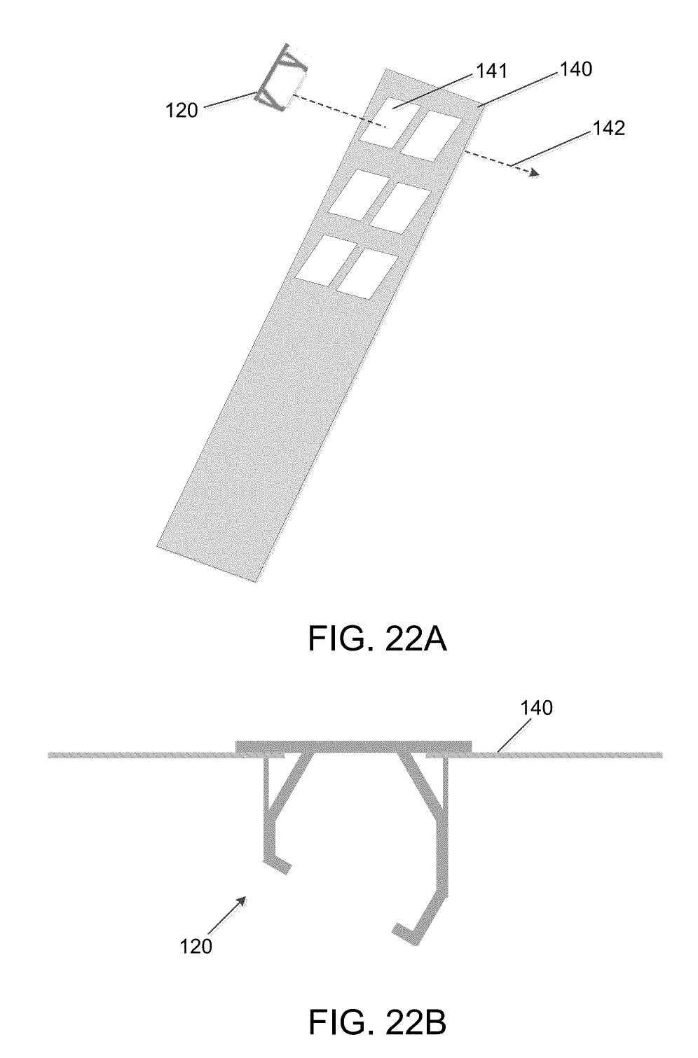

Referring to FIGS. 14 and 15, they show an existing light fixture 101 with tombstone electrical fitting 102 along with light bar 1. FIG. 14 and FIG. 15 depict how an existing light fixture 101 can be retrofitted with light bar 1. Tombstone 102 could be used with a pair of adapter bases 14, 15 or 16 attached to end base 2, 3 of light bar 1. In FIGS. 21 and 22, tombstones 102 are left in place in fixture 101, but not utilized. Light bar 1 is installed using clips 6, 8 and self-tapping hex screws 53, 54. Power supply 103 is positioned and DC wires 104 are electrically interconnected to the circuitry in light bar 1 with quick connectors 105 and 106.

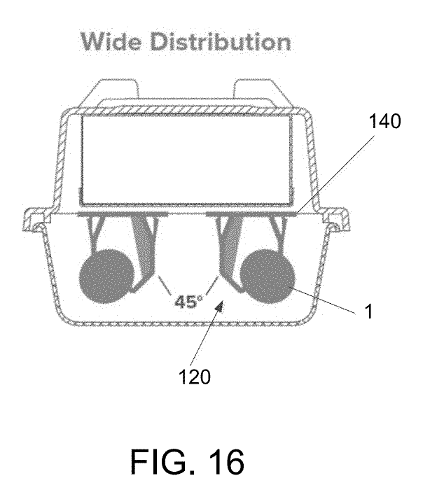

Referring now to FIGS. 16 through 21 what is shown is an embodiment of a Clip 120 adapted for a wide light distribution and an embodiment of a Clip 130 adapted for a narrow light distribution. Turning to FIG. 16, Clips 120 are integrated into a fixture 140 and adapted to hold light bars 1 at an angle relative to each other. In this illustrated embodiment the light bars 1 are at a 90° relative to each other, 45° relative to the fixture. Those of ordinary skill in the art will understand that the structure of the Clip 120 may be adapted for other angles as needed.

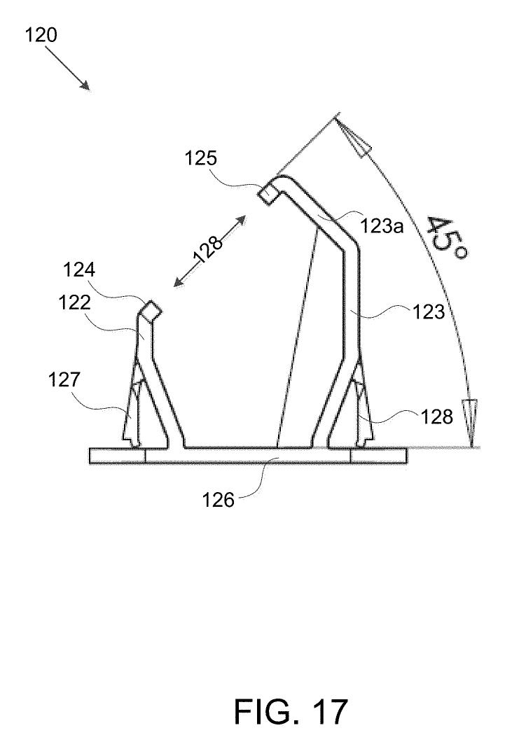

FIG. 17 is a side-view of the Clip 120. The Clip 120 has legs 122, 123 which are operable to flex slightly in the direction of arrows 129 and open as the legs 122, 123 slide over metal extrusion 9. The legs 122, 123 are then biased allowing feet 124, 125 to engage into grooves 31, 32 of extrusion 9 (see FIG. 5) and hold light bar 1 in place. In one embodiment the leg 123 is longer than the leg 122, and includes an extension 123a such that the area defined by the legs 122, 123 may receive hold the light bar 1, though the light bar 1 may not fill a substantial portion of the area defined by the legs 122, 123.

Clip 120 has a Base Feature 126 and fasteners 127, 128 that are adapted to fasten the Clip 120 to a fixture. In one embodiment the fasteners 127, 128 are leaf springs. The Clip 120 may be inserted to a through-hole in the fixture 140 such that the back surface of the fixture 140 firmly abuts the top surface of the Base feature 126, and fasteners 127, 128, which flex slightly, bias against the front surface of the fixture 140, pinching the fixture 140 between the fasteners 127, 128 and the Base feature 126. Other fastening techniques known in the art may be used instead of or in addition to those described herein, by way of non-limiting example, adhesives, bolts, screws, and the like.

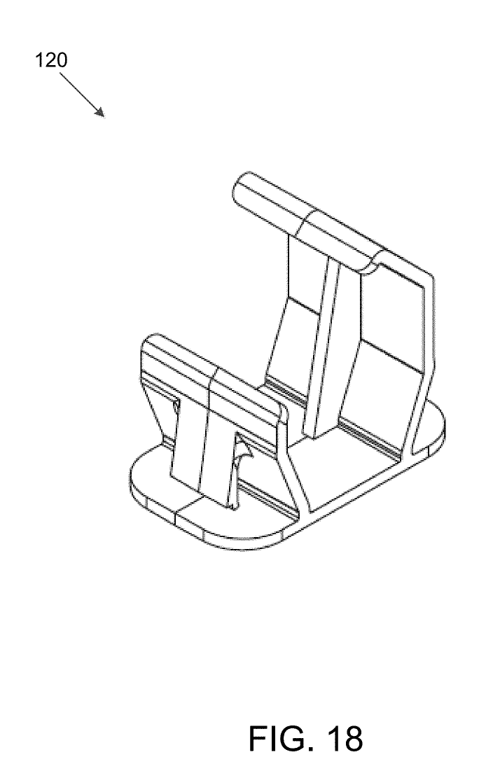

FIG. 18 is a perspective-view of the Clip 120 illustrated in FIG. 17.

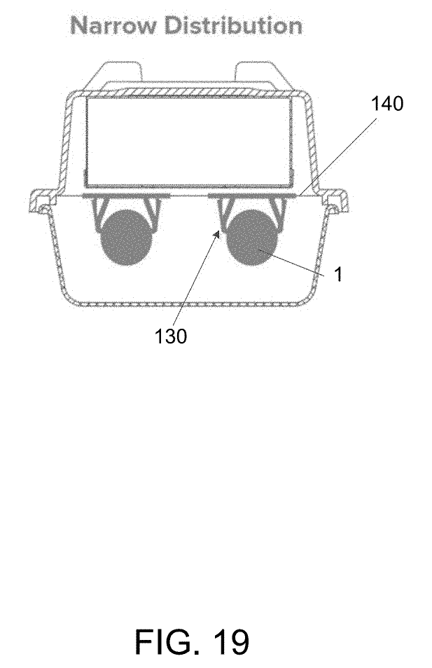

Referring now to FIG. 19, what is shown is an embodiment of a Clip 130 adapted for a narrow light distribution. Clips 130 are integrated into a fixture 140 and adapted to hold light bars 1 vertically, parallel to each other.

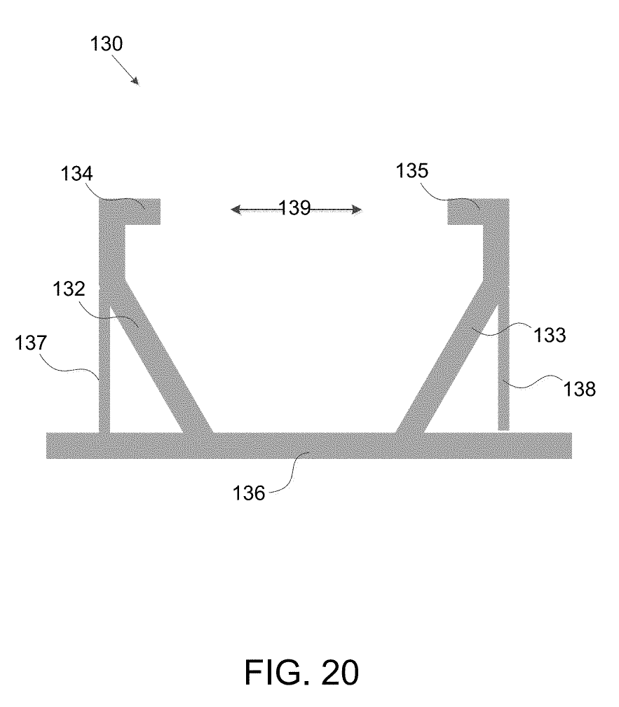

FIG. 20 is a side-view of the Clip 130. The Clip 130 has legs 132, 133 which are operable to flex slightly in the direction of arrows 139 and open as the legs 132, 133 slide over metal extrusion 9. The legs 132, 133 are then biased allowing feet 134, 135 to engage into grooves 31, 32 of extrusion 9 (see FIG. 5) and hold light bar 1 in place. In one embodiment the legs 132, 133 are substantially the same length.

Clip 130 has a Base Feature 136 and fasteners 137, 138 that are adapted to fasten the Clip 130 to a fixture. In one embodiment the fasteners 137, 138 are leaf springs. The Clip 130 may be inserted to a through-hole in the fixture 140 such that the back surface of the fixture 140 firmly abuts the top surface of the Base feature 136, and fasteners 137, 138, which flex slightly, bias against the front surface of the fixture 140, pinching the fixture 140 between the fasteners 137, 138 and the Base feature 136. Other fastening techniques known in the art may be used instead of or in addition to those described herein, by way of non-limiting example, adhesives, bolts, screws, and the like.

FIG. 21 is a perspective-view of the Clip 130 illustrated in FIG. 15.

Referring now to FIGS. 22A and 22B, which show the Clip 120 inserting into the through-holes 141 of the Fixture 140. FIG. 22A is a perspective view of the Clip 120 being inserted into a through-hole 141 along a trajectory 142. FIG. 22B illustrates the Clip 120 inserted into the through-hole 141 and fastened to the fixture 140.

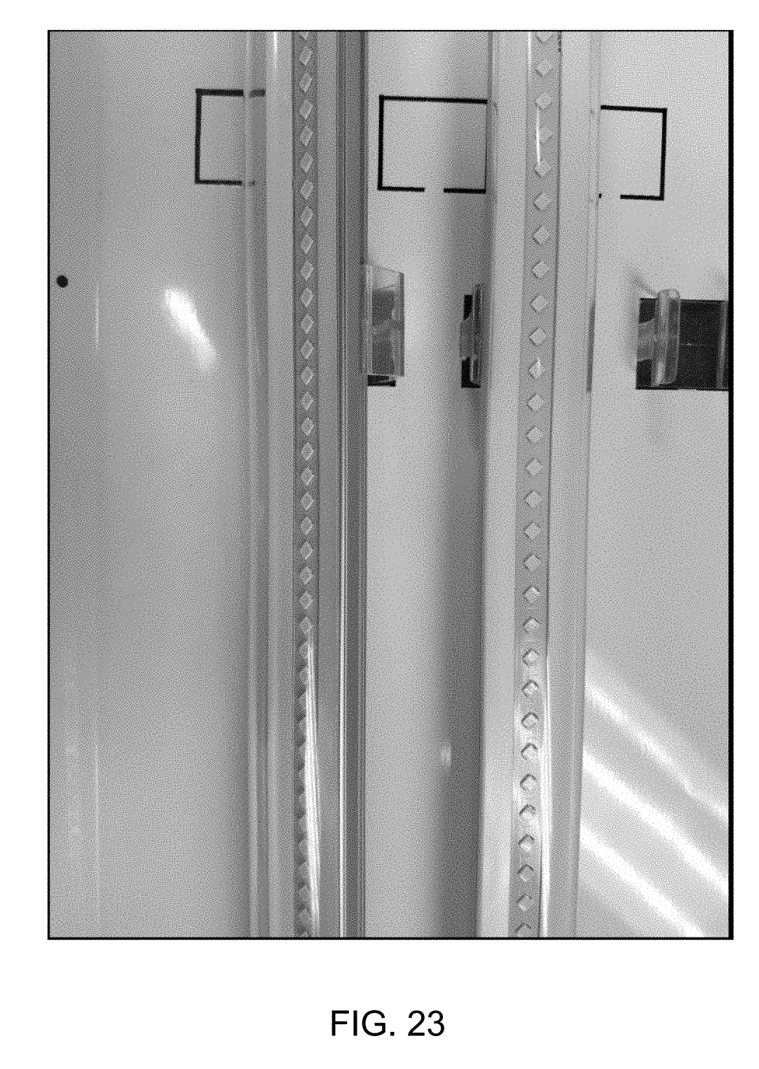

FIG. 23 illustrates a new fixture with an angled clip and a vertical clip installed and retaining LED light bars, according to an embodiment of the disclosure.

Once being apprised of this disclosure, one of ordinary skill in the art would be readily able to make and use the various embodiments of the disclosure. By way of non-limiting example, various embodiments of the disclosure facilitate ability to install light bars in fixtures to change light output, offer different kelvin options from stock that could be used as an LED light, quickly offer many different fixture types, facilitate procuring fixtures from many different sources, and change the beam pattern to meet utility requirements by utilizing clips without needing to change a fixture.

Various embodiments of the disclosure include both a method for the practice of replacing fluorescent tubular lamps with LED light bars while also describing the devices that provide the means of adapting the LED light bars into existing lamp fixtures.

Although operation illustrated by or in connection with FIGS. 1 through 23 and accompanying text recites acts performed in a particular order, embodiments of the present disclosure do not necessarily need to operate in that recited order. One of ordinary skill in the art would recognize many variations, including performing acts in parallel, or in a different order.

While certain illustrative embodiments have been described in connection with the figures, those of ordinary skill in the art will recognize and appreciate that the scope of this disclosure is not limited to those embodiments explicitly shown and described in this disclosure. Rather, many additions, deletions, rearrangements and other modifications to the embodiments described in this disclosure may be made to produce embodiments within the scope of this disclosure, such as those specifically claimed, including legal equivalents. In addition, features from one disclosed embodiment may be combined with features of another disclosed embodiment while still being within the scope of this disclosure, as contemplated by the inventors. As such, the invention is not to be defined only by the preceding illustrative description, but only by the claims which follow, and legal equivalents thereof.

We claim:

1. A light-emitting diode (“LED”) light bar offering multiple mounting options to an existing lamp fixture, the LED light bar comprising:
at least one base end cap adapted to receive a plurality of connecting adaptors for securing a light source bar; and
at least one mounting portion to removably fasten the LED light bar to a receptacle of the existing lamp fixture.

2. The LED light bar of claim 1, wherein the at least one base end cap is adapted to attach to the light source bar by a dove-tail locking boss.

3. The LED light bar of claim 1, wherein the plurality of connecting adaptors are adapted to snap into the at least one base end cap.

4. The LED light bar of claim 1, wherein the plurality of connecting adaptors are adapted to couple to a tombstone electrical mounting receptacle.

5. The LED light bar of claim 1, further comprising an extrusion comprising one or more pairs of symmetrical connecting grooves.

6. The LED light bar of claim 5, wherein the connecting grooves are adapted to support the LED light bar.

7. The LED light bar of claim 1, further comprising one or more self-tapping screws inserted into the mounting clip.

8. A mounting clip for supporting an LED light bar, the mounting clip comprising:
a base;
a pair of symmetrical leg portions extending from the base and defining a receptacle for an LED light bar; and
one or more fastening portions.

9. The mounting clip of claim 9, wherein the leg portions are flexible.

10. The mounting clip of claim 9, wherein the one or more fasteners are flexible and have a free end biased toward the base.

11. The mounting clip of claim 9, wherein one of the leg portions is longer than the other leg portion.

12. The mounting clip of claim 11, wherein each of the leg portions include a retaining portion extending at a non-zero angle.

13. The mounting clip of claim 12, wherein the retaining portions extend substantially toward each other.

14. The mounting clip of claim 12, wherein the angles are symmetrical from the horizontal.

15. The mounting clip of claim 9, wherein the leg portions are the same length.

16. The mounting clip of claim 15, wherein each of the leg portions include a retaining portion extending at the horizontal.

17. An LED light bar mounting system, the system comprising:
an LED light bar; and
at least one clip comprising a receptacle adapted to slidably receive and support the LED light bar.

18. The system of claim 17, wherein the at least one clip further comprises a base that is at an angle relative to a plane of an opening of the receptacle.

19. The system of claim 17, wherein the light bar further comprises a light source coupled to one or more end bases by one or more connectors that are adapted to permit rotation of the light source relative to the one or more base ends.

20. The system of claim 19, wherein the one or more connectors comprise
a rotating head having an axle; and
a base adapter having a bore and a plurality of bearings adapted to receive the axle and rotate around the axle.

21. A method of retrofitting a fluorescent tubular style lamp fixture with an LED light bar, the method comprising:
providing one or more clips adapted to retain an LED light bar; and
providing one or more LED light bars adapted to be supported by the one or more clips.

22. The method of claim 21, further comprising attaching the one or more clips to the fixture by self-tapping screws.

23. The method of claim 21, further comprising attaching the one or more clips to the fixture by inserting the one or more clips through a hole in the fixture.

24. The method of claim 23, wherein the hole is an existing hole in the fixture.

25. The method of claim 21, wherein the hole is a modified existing hole.

26. The method of claim 21, further comprising providing the LED light bar at an angle configured to approximate a light distribution of a fluorescent tubular lamp.

27. The method of claim 21, wherein the fluorescent tubular style lamp fixture is one approved by a testing organization or certifying body.

28. The method of claim 21, further comprising removing:
one or more fluorescent lamps; and
one or more lamp receptacles.
